(19) United States
(12) Patent Application Publication
(10) Pub. No.: US 2005/0022454 A1
(43) Pub. Date: Feb. 3, 2005

(54) Seal structure of fixing portion of weather strip

(75) Inventors: Hiroshi Aida, Wako-shi (JP); Kenichi Hori, Wako-shi (JP); Tomofumi Ichinose, Wako-shi (JP)

Correspondence Address: MERCHANT & GOULD PC, P.O. BOX 2903, MINNEAPOLIS, MN, 55402-0903, US

(73) Assignee: HONDA MOTOR CO., LTD., Minato-ku (JP)

(21) Appl. No.: 10/895,754

(22) Filed: Jul. 21, 2004

(30) Foreign Application Priority Data
Jul. 30, 2003 (JP) 2003-282389

(51) Int. Cl. E06B 7/16

(52) U.S. Cl. 49/490.1; 49/499.1

(57) ABSTRACT

A seal structure of a fixing portion of a weather strip of the present invention comprises the fixing portion that is fixed at a flange portion provided at a periphery of an opening of a car body, and a dam portion that is provided at a position opposite to a top end of the flange portion, wherein an adhesive sealant is coated within the dam portion, and wherein the top end of the flange portion contacts the adhesive sealant.

### BACKGROUND OF THE INVENTION

1. Field of the Invention

The present invention relates to a seal structure of a fixing portion of a weather strip set at a periphery of a car body opening such as a trunk room of an automobile.

2. Description of the Related Art

Conventionally, at car body openings such as a trunk room and doors of an automobile are formed flange portions along peripheries thereof and weather strips are fixed at the flange portions. A weather strip consists of a long packing made of rubber, and for example, is utilized for sealing insides of the trunk room and a car compartment with contacting the doors with a pressure when flappers of a trunk lid and the doors are closed. The trunk room and the car compartment are configured so that rain water, an outside air, and a sound do not come in, and so as to absorb an impact when the trunk lid and the doors are closed.

FIGS. 6A and 6B are drawings showing a structure of a fixing portion of a conventional weather strip: FIG. 6A is a section view showing a setting condition of a weather strip where a Styrofoam sponge is set at the fixing portion; FIG. 6B is a section view showing a setting condition of a weather strip where a butyl seal is set at the fixing portion.

As shown in FIGS. 6A and 6B, a conventional weather strip 100 is fixed by pressing a fixing portion 110 into a flange portion 210, which is formed at a periphery of an opening (not shown) of a car body 200. The fixing portion 110 consists of a groove formed like a top-open approximate rectangle, and on inner side walls 113 of the fixing portion 110, a plurality of protrusion pieces 111, which contact upper and lower surfaces of the flange portion 210 with a pressure, are protrudingly formed inward. The protrusion pieces 111 are obliquely formed in a backward direction of the fixing portion 110, and so as to be easily fit in the flange portion 210 with a pressure and to be difficultly pulled out of it.

The conventional weather strip 100 additionally provides a Styrofoam sponge 120 shown in FIG. 6A (see paraphrase 0011 and FIG. 5 in Japanese Patent Laid-Open Publication 2001-138830) or a butyl seal 130 made of butyl rubber shown in FIG. 6B in order to further ensure a sealing function with the flange portion 210.

The weather strip 100 of a conventional technology (the patent described above) shown in FIG. 6A prevents rain water and the like out of a car outside from invading a car inside by the Styrofoam sponge 120 strongly pushing the flange portion 210 of the car body 200. A sealing means by the Styrofoam sponge 120 has a possibility that the Styrofoam sponge 120 is fixed in no contact condition without reaching a top end 211 of the flange portion 210, with following a fluctuation of a dimension accuracy of the flange portion 210 of the car body 200 when the weather strip 100 is fixed at the flange portion 210. Because in this case the rain water and the like, which invade (arrow mark A-direction) an inside of the fixing portion 110 from the car outside, have a possibility that they pass between the top end 211 of the flange portion 210 and the Styrofoam sponge 120, flow in an arrow mark B-direction, and invade the car inside, there is a problem that the sealing function is poor. Therefore, another sealing means by the butyl seal 130 shown in FIG. 6B is frequently used.

The sealing means by the butyl seal 130 shown in FIG. 6B, after forming the weather strip 100, injects the butyl seal 130 on a back wall 112 of the fixing portion 110 in a following process and thereby coats it. Because a coating position of the butyl seal 130 in the weather strip 100 is the back wall 112 of the fixing portion 110 of the top-open approximate rectangle where the protrusion pieces 111 exist, they become obstacles and thus the coating position is poor in visibility, thereby coating work for the weather strip 100 being difficult to be performed. And because in the fixing portion 110 the back wall 112 is a flat-groove shape and the butyl seal 130 injected by a nozzle (not shown) easily spreads in directions of the inner side walls 113, there is a problem that an injection amount and coating position of the butyl seal 130 do not stabilize. Thus, because the coating position of the butyl seal 130 of the fixing portion 110 has a fluctuation of a coating height H, there is a possibility that the butyl seal 130 does not reach the top end 211 of the flange portion 210. In this case, for example, when as shown in FIG. 6B rain water invades the inside of the fixing portion 110 through the flange portion 210 (arrow mark C-direction), there is a possibility that the rain water flows in an arrow mark D-direction and invades the car inside.

In order that the butyl seal 130 completely reaches the top end 211 of the flange portion 210, it is thought to increase the injection amount of the butyl seal 130. However, when the injection amount of the butyl seal 130 is more, there is a problem that the butyl seal 130 pushes the flange portion 210 as the amount increases, the weather strip 100 floats from the flange portion 210, and a retention of the flange portion 210 lowers. In addition, as the injection amount of the butyl seal 130 increases, consumption thereof increases, thereby its becoming a cause of a cost increase.

Accordingly, is strongly requested a seal structure of a fixing portion of a weather strip that ensures a coating height and coating position of an adhesive sealant and has a sure sealing function.

### SUMMARY OF THE INVENTION

A first aspect of a seal structure of a fixing portion of a weather strip for solving the problems described above is the seal structure comprising the fixing portion that is fixed at a flange portion provided at a periphery of an opening of a car body, and a dam portion that is provided at a position opposite to a top end of the flange portion, wherein an adhesive sealant is coated within the dam portion, and wherein the top end of the flange portion contacts the adhesive sealant.

In accordance with the first aspect of the seal structure of the fixing portion of the weather strip of the present invention, in the fixing portion of the weather strip the dam portion is provided at the position opposite to the top end of the flange portion and the adhesive sealant is coated within the dam portion. Because the adhesive sealant is coated within the dam portion, it is suppressed to run off outside the dam portion by itself. Therefore, a coating position for coating the adhesive sealant is defined within the dam portion by its being provided at the fixing portion, whereby a fluctuation of the coating position of the adhesive sealant becomes suppressible.

Accordingly, in the adhesive sealant coated within the dam portion a height from a bottom surface of the dam portion to a surface of the adhesive sealant can be regulated by a height of the dam portion, whereby an injection amount of the adhesive sealant can be made constant.

Thus, because the injection amount and coating position of the adhesive sealant are stabilized by the dam portion, the fixing portion of the weather strip can always be fixed so that the adhesive sealant closely contacts the top end of the flange portion when fixing the weather strip at the flange portion.

A second aspect of a seal structure of a fixing portion of a weather strip of the present invention is the seal structure of the first aspect, wherein the dam portion comprises a lip portion provided at the fixing portion.

Because in accordance with the seal structure of the fixing portion of the weather strip of the second aspect the fixing portion of the weather strip comprises the lip portion provided at the fixing portion, the adhesive sealant, when it is coated within the lip portion, is suppressed to run off outside the lip portion by an inner side wall thereof. Therefore, a coating position for coating the adhesive sealant is defined within the lip portion and a fluctuation of the coating position of the adhesive sealant becomes suppressible.

Accordingly, in the adhesive sealant coated within the lip portion a height from a bottom surface of the dam portion to a surface of the adhesive sealant becomes adjustable by a height of the lip portion, whereby an injection amount of the adhesive sealant can be made constant.

Thus, because in the fixing portion of the weather strip the injection amount and coating position of the adhesive sealant are stabilized by the lip portion, the adhesive sealant can be injected so as to always closely contact the top end of the flange portion when fixing the weather strip at the flange portion.

A third aspect of a seal structure of a fixing portion of a weather strip of the present invention is the seal structure of the first aspect, wherein the dam portion comprises a pair of lip portions provided at the fixing portion.

Because in accordance with the third aspect of the seal structure of the fixing portion of the weather strip the fixing portion of the weather strip comprises the pair of the lip portions where the dam portion is provided at the fixing portion, the adhesive sealant, when it is coated within the pair of the lip portions, is suppressed to run off outside the lip portions by inner side walls of the pair of the lip portions. Therefore, a coating position for coating the adhesive sealant is defined within the pair of the lip portions and a fluctuation of the coating position of the adhesive sealant becomes suppressible.

Accordingly, in the adhesive sealant coated within the pair of the lip portions a height from a bottom surface of the dam portion to a surface of the adhesive sealant becomes adjustable by heights of the lip portions, whereby a injection amount of the adhesive sealant can be made constant.

Thus, because in the fixing portion of the weather strip the injection amount and coating position of the adhesive sealant are stabilized by the pair of the lip portions, the adhesive sealant can be fixed so as to always closely contact the top end of the flange portion when fixing the weather strip at the flange portion.

A fourth aspect of a seal structure of a fixing portion of a weather strip of the present invention is the seal structure of any of the second and third aspects, wherein the lip portion is protrudingly formed in a separation direction from the flange portion.

Because in accordance with the fourth aspect of the seal structure of the fixing portion of the weather strip the lip portion of the weather strip is protrudingly formed in the separation direction from the flange portion, the adhesive sealant, when it is coated within the lip portion, is suppressed to run off outside the lip portion by the protruded lip portion. Therefore, a coating position for coating the adhesive sealant is defined within the lip portion, whereby a fluctuation of the coating position of the adhesive sealant becomes suppressible.

Accordingly, in the adhesive sealant coated within the lip portion a height from a bottom surface of the dam portion to a surface of the adhesive sealant becomes adjustable by a height of the lip portion, whereby an injection amount of the adhesive sealant can be made constant.

Thus, because the injection amount and coating position of the adhesive sealant are stabilized by the lip portion, the fixing portion of the weather strip can always be fixed so that the adhesive sealant closely contacts the top end of the flange portion when fixing the weather strip at the flange portion.

In addition, by protrudingly forming the lip portion in the separation direction from the flange portion, it is possible to make the dam portion a shape spreading toward a flange side and a workability of work for coating the adhesive sealant be improved.

A fifth aspect of a seal structure of a fixing portion of a weather strip of the present invention is the seal structure of the first aspect, wherein the dam portion comprises a concave portion formed at the fixing portion.

Because in accordance with the fifth aspect of the seal structure of the fixing portion of the weather strip of the present invention the dam portion of the weather strip comprises the concave portion formed at the fixing portion, the adhesive sealant, when it is coated within the concave portion, is suppressed to run off outside the dam portion by a concavity. Therefore, a coating position for coating the adhesive sealant is defined within the concave portion, whereby a fluctuation of the coating position of the adhesive sealant becomes suppressible.

Accordingly, in the adhesive sealant coated within the concave portion a height from a bottom surface of the fixing portion to a surface of the adhesive sealant becomes adjustable by a height of the concave portion, whereby an injection amount of the adhesive sealant can be made constant.

Thus, because the injection amount and coating position of the adhesive sealant are stabilized by the concave portion, the fixing portion of the weather strip can always be fixed so that the adhesive sealant closely contacts the top end of the flange portion when fixing the weather strip at the flange portion.

A sixth aspect of a seal structure of a fixing portion of a weather strip of the present invention is the seal structure of the fifth aspect, wherein the concave portion is formed in a separation direction as a side wall of the concave portion approximates to the flange portion.

Because in accordance with the sixth aspect of the seal structure of the fixing portion of the weather strip the concave portion is formed in the separation direction as the side wall of the concave portion approximates to the flange portion, the adhesive sealant, when it is coated within the concave portion, is suppressed to run off outside the concave portion by the concavity of the concave portion. Therefore, a coating position for coating the adhesive sealant is defined within the concave portion, whereby a fluctuation of a coating position of the adhesive sealant becomes suppressible.

Accordingly, in the adhesive sealant coated within the concave portion a height from a bottom surface of the fixing portion to a surface of the adhesive sealant becomes adjustable by a height of the concave portion, whereby a injection amount of the adhesive sealant can be made constant.

Thus, because the injection amount and coating position of the adhesive sealant are stabilized by the concave portion, the fixing portion of the weather strip can always be fixed so that the adhesive sealant closely contacts the top end of the flange portion when fixing the weather strip at the flange portion.

In addition, by forming the concave portion in the separation direction from the flange portion as the side wall of the concave portion approximates to the flange portion, it is possible to make the dam portion a shape spreading toward a flange side and a workability of work for coating the adhesive sealant be improved.

A seventh aspect of a seal structure of a fixing portion of a weather strip of the present invention is the seal structure of any of the first to sixth aspects, wherein the dam portion is integrally formed with the fixing portion.

Because in accordance with the seal structure of the fixing portion of the weather strip of the seventh aspect the dam portion of the weather strip is integrally formed, it can be formed together with the fixing portion, and thereby is formed without an increase of a number of parts and an assembling man power.

### BRIEF DESCRIPTION OF THE DRAWINGS

FIG. 1 is a perspective view showing a seal structure of a fixing portion of a weather strip and a setting condition of the weather strip, related to an embodiment of the present invention.

FIG. 2 is an enlarged section view of FIG. 1 taken along an arrow mark view line X-X direction.

FIG. 3 is an enlarged section view of a substantial part, when a trunk is closed, showing the seal structure of the fixing portion of the weather strip and the setting condition of the weather strip related to the embodiment of the present invention.

FIGS. 4A and 4B are drawings showing variation examples related to an embodiment of the present invention: FIG. 4A is an enlarged drawing of a weather strip where a lip portion is set at nothing but a car outside of a fixing portion; FIG. 4B is an enlarged drawing of the weather strip where a lip portion is set at nothing but a car inside of the fixing portion.

FIG. 5 is a perspective view of a substantial part showing another variation example of a seal structure of a fixing portion of a weather strip and having a partial section of the weather strip, which comprises a dam portion consisting of a concave portion, related to an embodiment of the present invention.

FIGS. 6A and 6B are drawings showing a structure of a fixing portion of a conventional weather strip: FIG. 6A is a section view showing a setting condition of a weather strip where a Styrofoam sponge is set at the fixing portion; FIG. 6B is a section view showing a setting condition of the weather strip where a butyl seal is set at the fixing portion.

### DESCRIPTION OF THE PREFERRED EMBODIMENTS

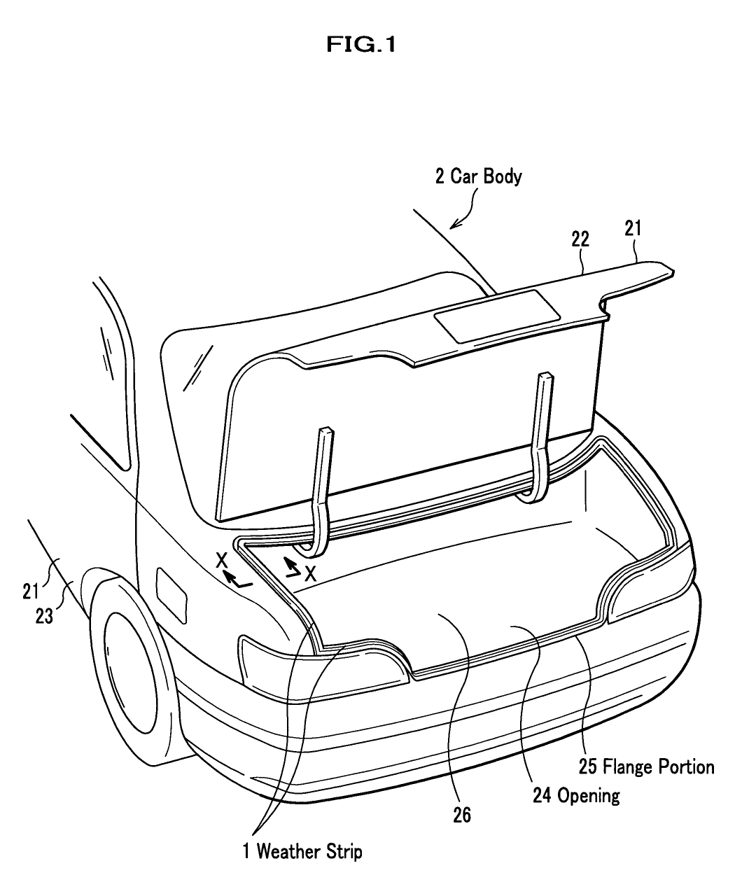

Here will be described a seal structure of a fixing portion of a weather strip related to an embodiment of the present invention, referring to FIGS. 1 to 3.

As shown in FIG. 1, a weather strip 1 is fixed at a flange portion 25 (see FIG. 3), which is formed at a periphery of an opening 24 of flappers 21 such as a trunk lid 22 and door 23 of a car body 2, and has a sealing function for preventing rain water and noises from invading a car inside 26 such as a trunk room and a buffer function for buffering an impact in closing the flappers 21.

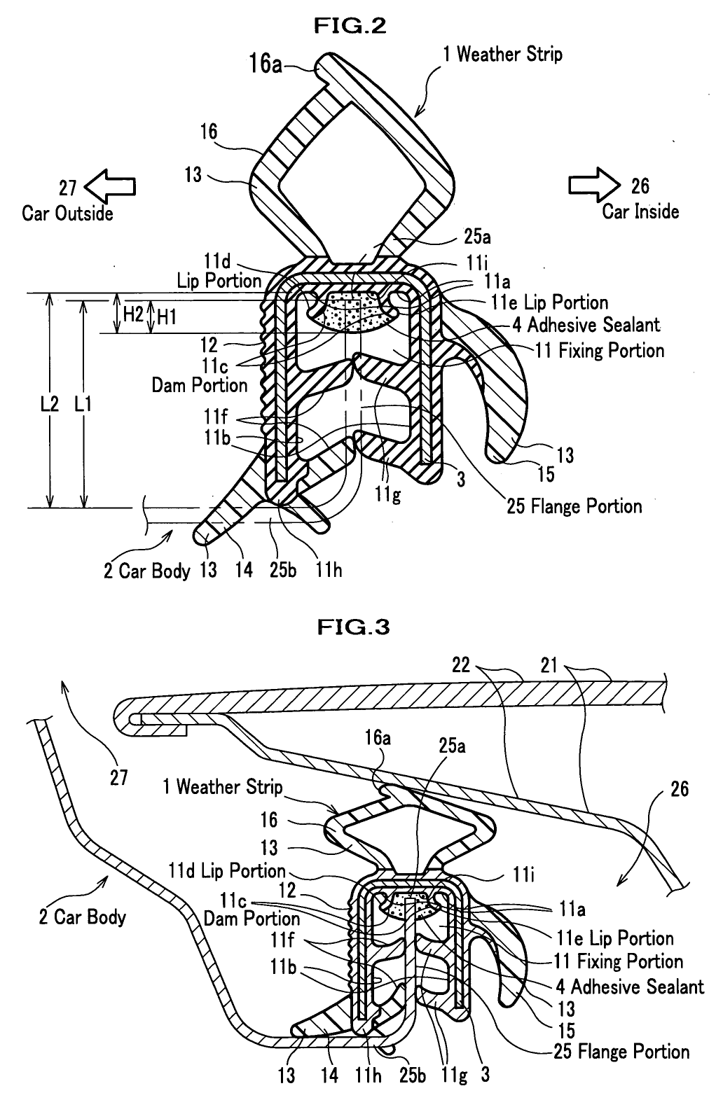

As shown in FIGS. 2 and 3, the weather strip 1 is integrally formed of a hard member 12 for forming a base portion such as a fixing portion 11; a soft member 13 for forming seal portions such as seal portions 14 and 15 and a hollow seal portion 16, which are insert-shaped in two colors in the hard member 12; and a reinforcement member 3 insert-shaped within the hard member 12. The weather strip 1 is fixed in the opening 24 of the car body 2 by fixing the fixing portion 11 at the flange portion 25. The weather strip 1 is set toward a closing direction of the flapper 21 so that the hollow seal portion 16 approximately orthogonally abuts on the flapper 21.

The hard member 12 is formed of any of hard rubbers and soft synthetic resins in order that a shape of the fixing portion 11 of the weather strip 1 is not deformed. Within the hard member 12 is insert-shaped the reinforcement member 3 comprised of a metal sheet, and furthermore, the member 3 is formed into a structure difficult to be deformed.

The soft member 13 is formed of soft rubber, soft synthetic resin, and the like so as to closely contact the car body 2 and flapper 21, where the member 13 abuts on.

The fixing portion 11 is a portion formed in order to fix the weather strip 1 at the flange portion 25 and is formed of a groove, whose section is a top-open approximate rectangle. On the back walls 11a of the fixing portion 11 dam portions 11c are formed at positions opposite to a top end 25a of the flange portion 25, and a plurality of protrusion pieces 11f and 11g are formed on left/right inner side walls 11b.

The dam portions 11c are, for example, portions, where the top end 25a of the flange portion 25 is pressed and an adhesive sealant 4 is coated, and are formed along a center line (not shown) of the back walls 11a. The dam portions 11c are, for example, formed by a pair of lip portions 11d and 11e provided on the back walls 11a.

The lip portions 11d and 11e are provided on the back walls 11a with keeping a distance, respectively, and top ends thereof are formed so as to spread like a bottom-open reverse V letter with protruding in separation directions from the flange portion 25. The two lip portions 11d and 11e are disposed like parallel rails, thereby forming the dam portions 11c like a groove.

The protrusion pieces 11f and 11g are so called lip packings, which are protrudingly formed inward from a plurality of opposite positions to left/right inner side walls 11b, respectively, and have a role of sealing an inside of the fixing portion 11 with contacting upper/lower surfaces of the flange portion 25 with a pressure. The protrusion pieces 11f and 11g are obliquely formed toward directions of the back walls 11a of the fixing portion 11, and so that the flange portion 25 is easy to be pressed into and difficult to be pulled out of the fixing portion 11.

The seal portion 14 has, as shown in FIG. 3, a role of a packing for preventing rain water and the like from invading the inside of the fixing portion 11 from between the seal portion 14 and the flange portion 25 by a top end of the seal portion 14 by contacting the car body 2 with a pressure and closely contacting it, when fixing the weather strip 1 is fixed at the flange portion 25.

The hollow seal portion 16 is a portion like a tube, whose section is formed to an approximate rhombus by the soft member 13, and has an elasticity of bending in a direction of the flapper 21. At a top end of the hollow seal portion 16 is integrally formed a convex portion 16a that abuts on the flapper 21 when it is closed. Because the convex portion 16a is formed toward a direction of a car outside 27, it has a role of preventing rain water and the like from invading the car inside 26 from the car outside 27.

The flange portion 25 is comprised of a metal sheet formed at the periphery of the opening 24 (see FIG. 1) of the car body 2, and the top end 25a thereof is bent toward a direction of the flapper 21 which occludes the opening 24.

As shown in FIG. 2, for example, providing that a length of the flange portion 25, which is squarely bent, is L1 and a depth of the fixing portion 11 from an opening end 11h at a side of the car body 2 to the back wall 11a is L2, make L1<L2 and thus form the length L1 of the flange portion 25 a little bit shorter than the depth L2 of the fixing portion 11.

Because when the weather strip 1 is fixed, the top end 25a is positioned with a base end 25b abutting on the opening end 11h of the flange portion 25, the top end 25a is configured so as to be pressed into till a position of a predetermined depth H1 within the adhesive sealant 4.

The adhesive sealant 4 is, for example, comprised of a tangible liquid seal consisting of a butyl seal and the like made of butyl rubber. After forming the weather strip 1, the adhesive sealant 4 is injected within the lip portions 11d and 11e of the back walls 11a of the fixing portion 11 till a height H2 by a straw-like nozzle (not shown) and thereby is coated.

Next, will be described an action of the seal structure of the fixing portion of the weather strip related to the embodiment of the present invention together with a fixing procedure, referring to FIGS. 2 and 3.

First, insert the reinforcement member 3 as a core member and primarily shape a portion formed of the hard member 12. Thus the lip portions 11d and 11e of the fixing portion 11 of the weather strip 1 and the protrusion pieces 11f and 11g are formed. Because the lip portions 11d and 11e and the protrusion pieces 11f and 11g are formed along the fixing portion 11 like a groove, they can be easily extruded and formed.

In addition, shape the seal portions 14 and 15 and the hollow seal portion 16, which are integrally formed into the hard member 12, in two colors by the soft member 13. Because the seal portions 14 and 15 and the hollow seal portion 16 are formed along an outside of the fixing portion 11, they can be easily extruded and formed.

Insert a nozzle tip (not shown) for coating the adhesive sealant 4 in the fixing portion 11 and coat the adhesive sealant 4 within the dam portions 11c between the lip portions 11d and 11e. Thus the weather strip 1 is completed.

Meanwhile, the dam portions 11c, which are comprised of the lip portions 11d and 11e, are provided at the positions opposite to the top end 25a of the flange portion 25 where the adhesive sealant 4 is coated. Thus the adhesive sealant 4 is suppressed to run off outside the lip portions 11d and 11e by themselves, and thereby a coating position is defined within the dam portions 11c. Therefore, in the adhesive sealant 4 the height H2 from the back walls 11a (bottom surface) of the dam portions 11c to the surface of the adhesive sealant 4 becomes adjustable in accordance with heights of the lip portions 11d and 11e, an injection amount of the adhesive sealant 4 can be made constant.

In addition, because the dam portions 11c are provided at the fixing portion 11, the coating position for coating the adhesive sealant 4 is defined within the dam portions 11c, and thereby a fluctuation of the coating position of the adhesive sealant 4 becomes suppressible.

Accordingly, although in work of coating the adhesive sealant 4 on the fixing portion 11 the coating position is invisible due to the protrusion pieces 11f and 11g and thus a visibility is poor, it becomes easy to coat the adhesive sealant 4 because the coating position and injection amount of the adhesive sealant 4 are stabilized.

Next, fit the weather strip 1 thus formed in the flange portion 25. Whereat, first of all the protrusion pieces 11f and 11g within the fixing portion 11 contact the upper/lower surfaces of the flange portion 25 with a pressure and thereby closely contact them. Therefore, the weather strip 1 has water/sound proofing properties thanks to the protrusion pieces 11f and 11g.

Furthermore, when deeply fitting the weather strip 1 in the flange portion 25, the seal portion 14 abuts on the base end 25b of the flange portion 25 and thereby closely contacts it. Therefore, the weather strip 1 can prevent rain water, noises, and the like from invading the inside of the fixing portion 11 thanks to the adhesive sealant 4.

Furthermore, when deeply fitting the weather strip 1 in the flange portion 25, the opening end 11h of the weather strip 1 abuts on the base end 25b of the flange portion 25 and thereby the fitting-in stops. Whereat, the top end 25a of the flange portion 25 is, as shown in FIG. 3, pressed into within the adhesive sealant 4, is positioned at a position separated a little from a bottom portion 11i, which is formed by the dam portions 11c, and thus closely contact the adhesive sealant 4. Accordingly, the inside of the fixing portion 11 is completely separated into two, the car outside 27 and the car inside 26, by the flange portion 25, and it is possible to prevent rain water and the like, which invade the inside of the fixing portion 11 from the car outside 27 of the car body 2, from coming in the car inside 26 with passing through the top end 25a of the flange portion 25.

Thus, because the injection amount and coating position of the adhesive sealant 4 are stabilized, the adhesive sealant 4 results in closely contacting the top end 25a of the flange portion 25, and thereby the weather strip 1 fixed at the flange portion 25 can improve the water proofing property. Therefore, can be eliminated a conventional water proofing problem that there is a possibility that water invades the car inside 26, deriving from that the adhesive sealant 4 is injected without reaching the top end 25a of the flange portion 25.

In addition, because the injection amount of the adhesive sealant 4 is stabilized and thereby a much injection amount of the adhesive sealant 4 can be eliminated, a consumption amount of the adhesive sealant 4 is suppressed and a cost reduction can be achieved.

Meanwhile, the present invention is not limited to the embodiment and various makeovers and variations are available without departing from the spirit and scope of the invention: It goes without saying that the present invention covers makeover and variation inventions.

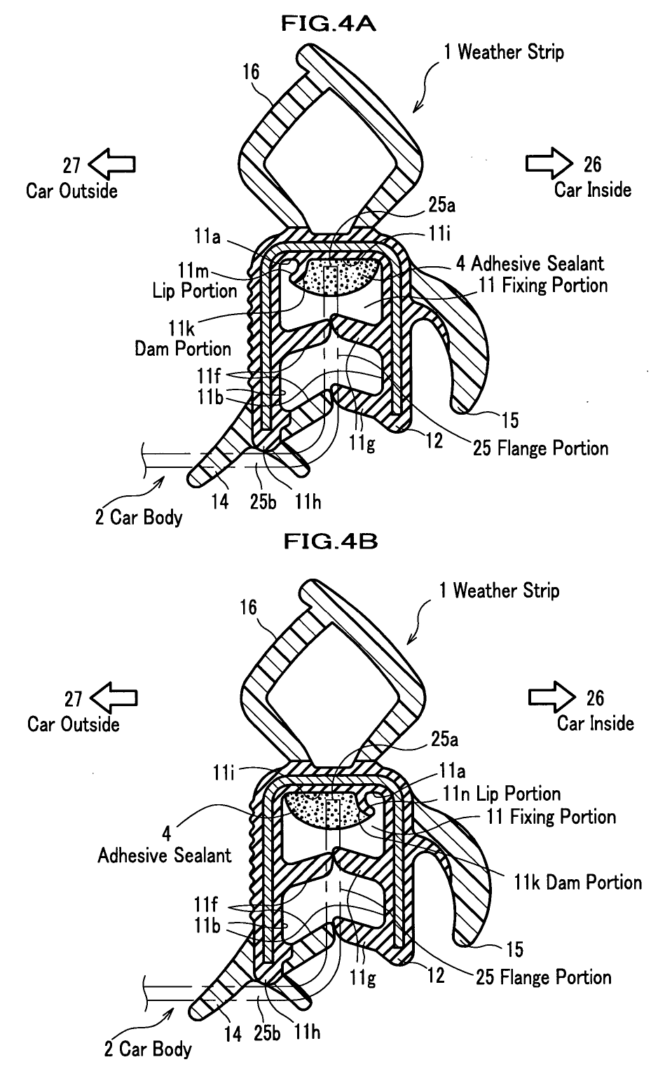

FIGS. 4A and 4B are drawings showing variation examples related to an embodiment of the present invention: FIG. 4A is an enlarged drawing of a weather strip where a lip portion is set at nothing but a car outside of a fixing portion; FIG. 4B is an enlarged drawing of a weather strip where a lip portion is set at nothing but a car inside of the fixing portion.

The dam portions 11c, which are formed at the fixing portion 11 shown in FIGS. 2 and 3, are not limited to the lip portions 11d and 11e in the embodiment described above; and is available anything that is formed on the back wall 11a of the fixing portion 11, stabilizes the coating position of the adhesive sealant 4, and has a function that the adhesive sealant 4 does not run off outside the dam portions 11c.

For example, as shown in FIGS. 4A and 4B, a dam portion 11k may also be comprised of one of a lip portion 11m and lip portion 11n, each of which is integrally formed on a relevant back wall 11a of the fixing portion 11.

Thus configured, because the adhesive sealant 4 injected from a nozzle (not shown) can be coated so as to pool within the dam portion 11k where the top end 25a of the flange portion 25 is disposed, the adhesive sealant 4 results in being always coated in a stable condition.

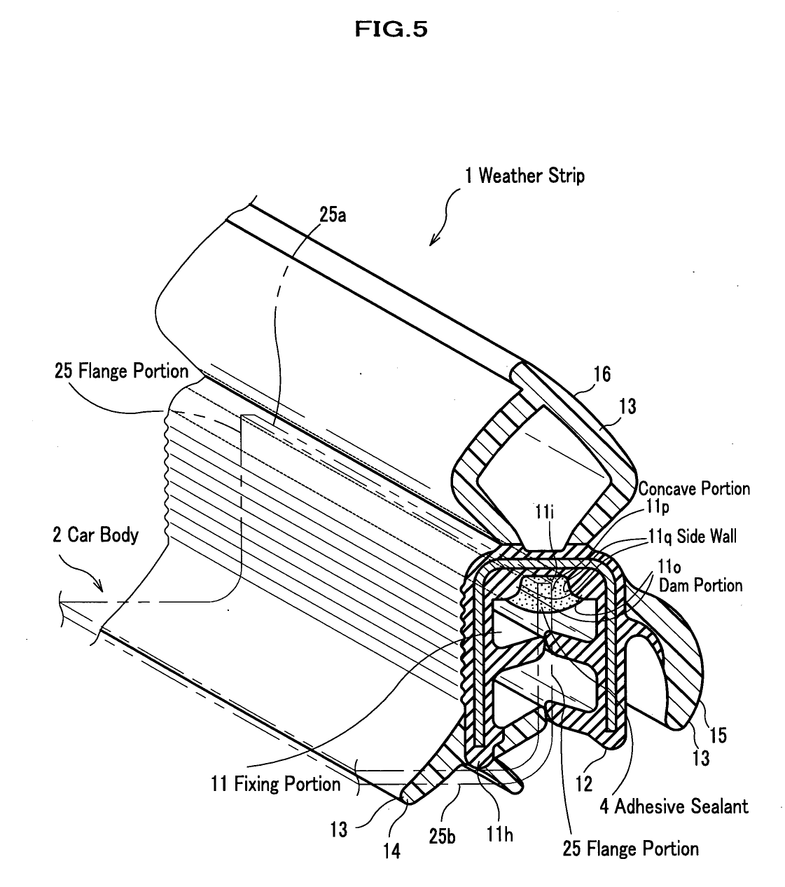

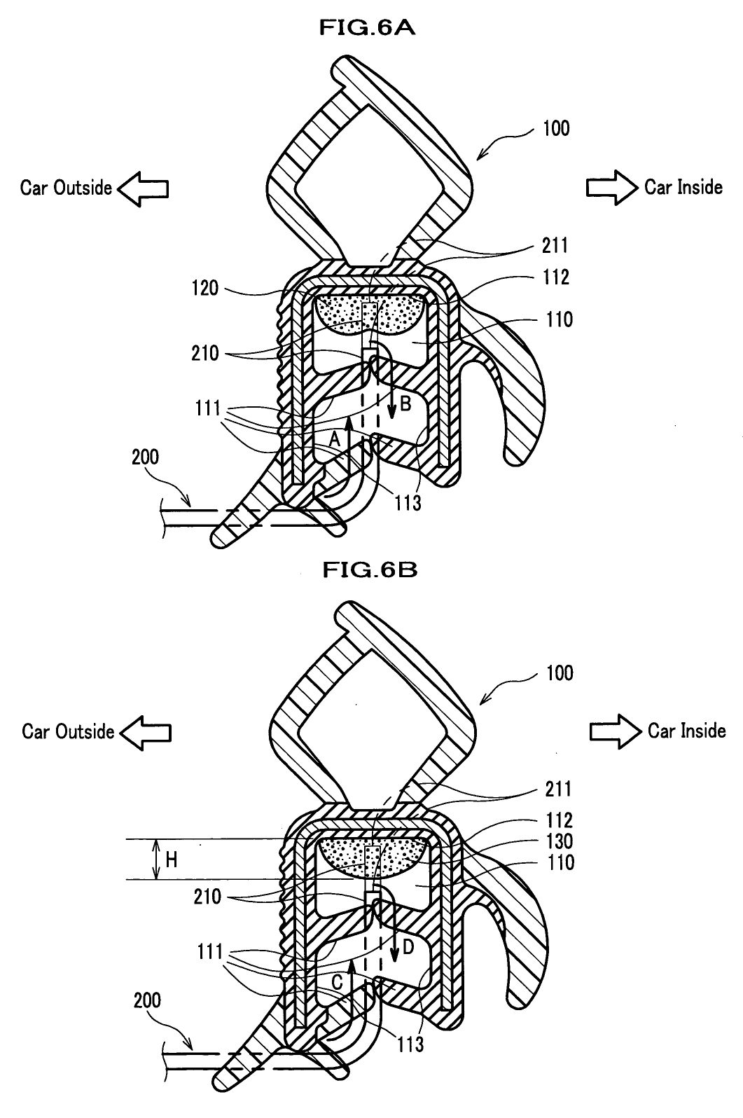

FIG. 5 is a perspective view of a substantial part showing another variation example of a seal structure of a fixing portion of a weather strip and having a partial section of the weather strip, which comprises a dam portion consisting of a concave portion, related to an embodiment of the present invention.

In addition, the dam portions 11c shown in FIGS. 2 and 3 are not limited to the lip portions 11d and 11e, which are protrudingly formed from the back walls 11a in the embodiment described above; and is available anything that has a function to pool the adhesive sealant 4 and enables it not to run off outside the dam portions 11c.

For example, as shown in FIG. 5, the dam portions 11o may be comprised of a concave portion 11p formed at the fixing portion 11. The concave portion 11p is comprised of a groove-like blind hole, which is integrally formed on the bottom portion 11i of the fixing portion 11, and is formed in a separation direction as side walls 11q of the concave portion 11p approximate to the flange portion 25.

Thus configured, because the adhesive sealant 4 injected from a nozzle (not shown) can be coated so as to pool within the dam portions 11o where the top end 25a of the flange portion 25 is disposed, the adhesive sealant 4 results in being always coated in a stable condition.

1. A seal structure of a fixing portion of a weather strip, the structure comprising:
said fixing portion;
a flange portion provided at a periphery of an opening of a car body;
a dam portion; and
an adhesive sealant,
wherein said fixing portion is fixed at said flange portion and said dam portion is provided at a position opposite to a top end of said flange portion, wherein said adhesive sealant is coated within said dam portion, and wherein the top end of said flange portion contacts said adhesive sealant.

2. A seal structure of a fixing portion of a weather strip according to claim 1, wherein said dam portion comprises a lip portion provided at said fixing portion.

3. A seal structure of a fixing portion of a weather strip according to claim 1, wherein said dam portion comprises a pair of lip portions provided at said fixing portion.

4. A seal structure of a fixing portion of a weather strip according to claim 2, wherein said lip portion is protrudingly formed in a separation direction from said flange portion.

5. A seal structure of a fixing portion of a weather strip according to claim 3, wherein said lip portion is protrudingly formed in a separation direction from said flange portion.

6. A seal structure of a fixing portion of a weather strip according to claim 1, wherein said dam portion comprises a concave portion formed at said fixing portion.

7. A seal structure of a fixing portion of a weather strip according to claim 6, wherein said concave portion is formed in a separation direction as a side wall of the concave portion approximates to said flange portion.

8. A seal structure of a fixing portion of a weather strip according to claim 1, wherein said dam portion is integrally formed with said fixing portion.

9. A seal structure of a fixing portion of a weather strip according to claim 2, wherein said dam portion is integrally formed with said fixing portion.

10. A seal structure of a fixing portion of a weather strip according to claim 3, wherein said dam portion is integrally formed with said fixing portion.

11. A seal structure of a fixing portion of a weather strip according to claim 4, wherein said dam portion is integrally formed with said fixing portion.

12. A seal structure of a fixing portion of a weather strip according to claim 5, wherein said dam portion is integrally formed with said fixing portion.

13. A seal structure of a fixing portion of a weather strip according to claim 6, wherein said dam portion is integrally formed with said fixing portion.

14. A seal structure of a fixing portion of a weather strip according to claim 7, wherein said dam portion is integrally formed with said fixing portion.
